(19) United States
(12) Patent Application Publication
(10) Pub. No.: US 2008/0189158 A1
(43) Pub. Date: Aug. 7, 2008

(54) Distributed decision making for supply chain risk assessment

(76) Inventors: Jerzy Bala, Potomac Falls, VA (US); B. K. Gogia, Ashburn, VA (US); Jesus Mena, El Paso, TX (US)

Correspondence Address: SEYFARTH SHAW LLP, 131 S. DEARBORN ST., SUITE 2400, CHICAGO, IL, 60603-5803, US

(21) Appl. No.: 12/069,948

(22) Filed: Feb. 14, 2008

Related U.S. Application Data
(63) Continuation-in-part of application No. 11/904,982, filed on Sep. 28, 2007.
Application No. 11/904,982 is a continuation-in-part of application No. 10/616,718, filed on Jul. 10, 2003, now Pat. No. 7,308,436.
(60) Provisional application No. 60/901,301, filed on Feb. 15, 2007.
(60) Provisional application No. 60/394,526, filed on Jul. 10, 2002.
(60) Provisional application No. 60/394,527, filed on Jul. 10, 2002.

(51) Int. Cl. G06F 15/18; G06F 15/16; G06Q 10/00

(52) U.S. Cl. 705/7; 706/10; 706/12

(57) ABSTRACT

A method for determining supply chain risks is provided. The method including the steps of: providing a plurality of data locations, each data location having an agent and data elements; performing distributed data mining by each of the agents using the data elements at the respective data location to produce a candidate decision for the respective location; determining a global decision from the candidate decisions, the global decision covering the data elements at all of the data locations; and generating predictive risk scores for the data elements from the global decision.

### CROSS-REFERENCE TO RELATED APPLICATIONS

This application claims priority to provisional application No. 60/901,301, filed on Feb. 14, 2007, incorporated herein by reference. This application is also a continuation-in-part of application Ser. No. 11/904,982, filed on Sep. 28, 2007, which is a continuation in part of application Ser. No. 10/616,718, filed on Jul. 10, 2003, now U.S. Pat. No. 7,308,436, which claims priority to provisional application Ser. Nos. 60/394,526 and 60/394,527, filed on Jul. 10, 2002, all of which are incorporated herein by reference.

### FIELD OF THE INVENTION

This present application relates generally to methods for analyzing supply chain information, and in more particular applications, to risk assessment for supply chain management.

### BACKGROUND

International cargo supply chain security is a global issue that cannot be successfully achieved unilaterally. From a Department of Homeland Security (DHS) perspective, the most effective supply chain security measures are those that involve assessing risks and identifying threats presented by cargo shipments before they reach the United States. For international containerized cargo, this assessment and identification is most effective if it is conducted before a container is loaded onto a vessel destined for the United States. Yet, this is only half of the necessary analysis. The global supply chain is bidirectional, requiring domestic efforts to ensure the integrity of both inbound and outbound cargo. Such an effective cargo security strategy requires a multi-layered, unified approach that must be international in scope. Numerous U.S. Government and World Custom's Organization members have proclaimed and introduced numerous and widely varying initiatives primarily aimed at stopping weapon of mass destruction from entering into the United States.

World-wide container traffic is a critical component of global supply chains (about 90% of international trade moves or is transported in cargo containers). In the United States, almost half of incoming trade (by value) arrives by containers on board container ships, with almost 16 million cargo containers arriving and being offloaded at U.S. seaports each year. Containerized traffic disruptions can reduce a company's revenue, cut its market share, inflate its costs, send it over budget, and threaten production and distribution.

On the other hand, U.S. manufacturers are using off-shore facilities for manufacturing and distribution to optimize the operations. In reality, manufacturing today is conducted through a complex network of firms that produce and assemble components into finished products. The links between firms in manufacturing networks form international supply chains. The science of logistics, aided by the application of advanced information technologies, has permitted these networks to increase output and lower costs by virtually eliminating inventories of components waiting for assembly and inventories of finished products waiting for shipment to retailers or consumers. Today international supply chains are one reason for the remarkable productivity improvements, and corresponding economic growth, experienced in North America and in the EU.

Yet, this shift to networked manufacturing has come with new risks. When whole networks of firms are dependent on just-in-time deliveries, even brief disruptions to shipping schedules can be costly. By bringing a “war without fronts” to an infrastructure mostly owned and operated by private business, the realities of 9/11 shifted traditional customs roles in security and public safety to a new venue—away from the conventional battlefield and onto what was heretofore viewed as the venue of private operations.

Also, security of the supply chain is no longer just dealing with theft and/or the smuggling of persons and counterfeit goods. From shippers' and carriers' perspectives, issues of international cargo supply chain security are extremely important to their business. The key is—can the manufacture of products have some information in advance about the counterfeit of products coming from all over the world.

Following 9/11 there is an urgent need for new techniques that screen containers with high predictive accuracy for the detection of high-risk containers. One of the core elements of the Container Security Initiative is using intelligence and automated information to identify and target high-risk containers to be pre-screened before they arrive at U.S. ports. The key element in the pre-screening process is the identification of distributed data elements that represents risk relevant information for a given container en route to its destination, this may involve data elements associated to the transport, storage and path containers take on their way to our ports.

Data Elements for Risk Assessment

We are experiencing an explosive growth in capabilities to both generate and collect supply chain data. Advances in data collection as well as the computerization of many areas of supply-chain have flooded its stakeholders with data and has generated an opportunity for its effective use in predicting risk scores.

The “risk relevant” information can be extracted from order data, production data, digital commercial invoice data, transportation partner data, supplier cargo bookings, at origin data, in transit data, and fright location data. Such supply chain data tends to be “siloed” or stored in a single location in space and time. Real-time intelligence into these globally “distributed data silos” can allow accurate and timely visibility on risk vulnerability for supply chain stakeholders. However, current decision support systems are inadequate and characterized by data warehouse based architectures, with main operational challenges concentrated on data integration steps (i.e., batch-mode, not real-time, not privacy preserving, etc).

### SUMMARY

In one form, a method for determining supply chain risks is provided. The method including the steps of: providing a plurality of data locations, each data location having an agent and data elements; performing distributed data mining by each of the agents using the data elements at the respective data location to produce a candidate decision for the respective location; determining a global decision from the candidate decisions, the global decision covering the data elements at all of the data locations; and generating predictive risk scores for the data elements from the global decision.

According to one form, a method for determining supply chain risks is provided. The method including the steps of: providing a plurality of data locations, each data location having an agent and data elements; performing distributed data mining by each of the agents using the data elements at the respective data location to produce a candidate decision for the respective location; passing each of the candidate decisions from the respective data location to a central mediator; determining a global decision by the mediator based on the candidate decisions; and generating predictive risk scores for the data elements from the global decision.

In accordance with one form, a method for determining supply chain risks is provided. The method including the steps of: providing a plurality of data locations, each data location having an agent and data elements; performing distributed data mining by a first agent using the data elements at a first data location to produce a first candidate decision; passing the first candidate decision to a second data agent at a second location; performing distributed data mining by the second agent using the data elements at the second data location to produce a second candidate decision; determining a global decision from the candidate decisions, the global decision covering the data elements at all of the data locations; and generating predictive risk scores for the data elements from the global decision.

In one form, the step of performing distributed data mining utilizes a decision tree.

According to one form, steps a performing distributed data mining and determining a global decision are performed by a synchronized decision-making process.

In accordance with one form, the steps a performing distributed data mining and determining a global decision are performed by a sequential decision-making process.

In one form, the data elements include information specific to shipping containers such that the risk scores are generate for each specific shipping container.

According to one form, the method further includes the step of reporting a high-risk score.

In accordance with one form, the data elements include information related to at least one of: seller data, merchandise description, location, quantity, weight, date, parties associated with a shipment, vessel, crew, customs manifest and proof of delivery.

According to one form, a system for determining supply chain risks is provided. The system includes at least one memory unit at each of a plurality of locations, a processing unit at each of the plurality of locations and a mediator. The at least one memory unit is for storing data elements. Each processing unit including an agent configured to perform distributed data mining using the data elements at the respective data location to produce a candidate decision for the respective location. The mediator is configured to determine a global decision from the candidate decisions, the global decision covering the data elements at all of the data locations, the mediator also being configured to generate predictive risk scores for the data elements from the global decision.

According to one form, the mediator is a central processing unit.

In one form, the mediator is at least one of the processing units at one of the plurality of locations.

Other forms are also contemplated as understood by those skilled in the art.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its constructions and operation, and many of its advantages should be readily understood and appreciated.

FIG. 1 is a diagrammatic representation of one form of a distributed data mining method and system;

FIG. 2 is a diagrammatic representation of an agent-mediator communication mechanism;

FIG. 3 is a diagrammatic representation of one form of mediation between two decision trees;

FIG. 4 is a diagrammatic representation of one form of a synchronized decision-making process;

FIG. 5 is a diagrammatic representation of one form of sequential decision-making process;

FIG. 6 is a diagrammatic representation of another form of a sequential decision-making process; and

FIG. 7 is diagrammatic representation of an example of a sequential decision-making process for risk scoring containerized traffic.

### DETAILED DESCRIPTION

Supply chain risk assessment can be performed in a variety of manners using data analysis techniques. In one form, distributed data mining is utilized as part of the supply chain risk assessment method.

Distributed Data Mining

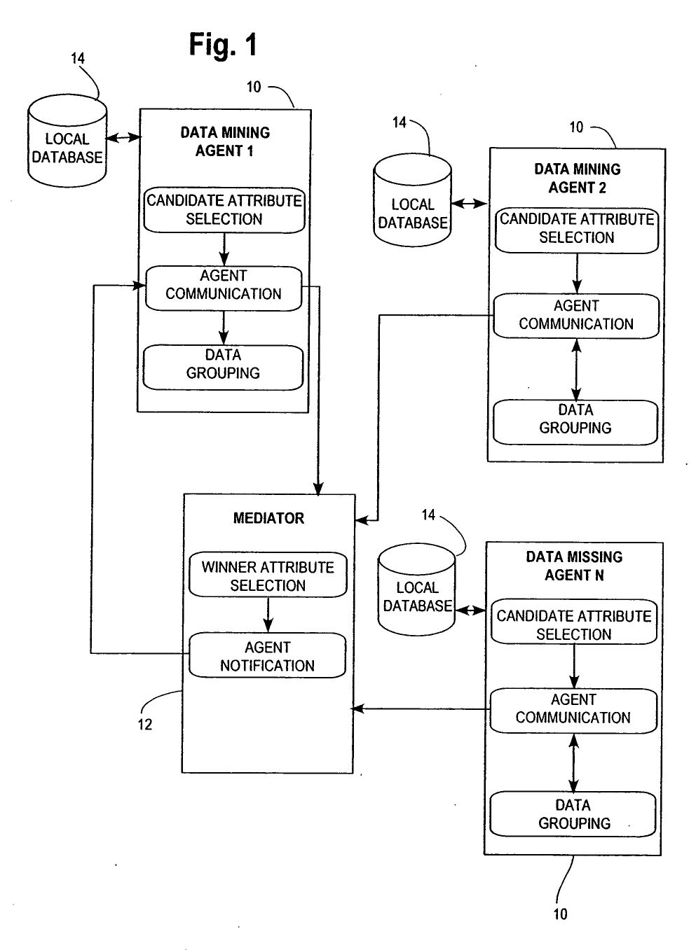

FIG. 1 illustrates one basic form of distributed data mining. In one form, distributed mining is accomplished via a synchronized collaboration of agents 10 as well as a mediator component 12. (see Hadjarian A., Baik, S., Bala J., Manthorne C. (2001) “InferAgent—A Decision Tree Induction From Distributed Data Algorithm,” 5th World Multiconference on Systemics, Cybernetics and Informatics (SCI 2001) and 7th International Conference on Information Systems Analysis and Synthesis (ISAS 2001), Orlando, Fla.). The mediator component 12 facilitates the communication among agents 10. In one form, each agent 10 has access to its own local database 14 and is responsible for mining the data contained by the database 14.

Distributed data mining results in a set of rules generated through a tree induction algorithm. The tree induction algorithm, in an iterative fashion, determines the feature which is most discriminatory and then it dichotomizes (splits) the data into classes categorized by this feature. The next significant feature of each of the subsets is then used to further partition them and the process is repeated recursively until each of the subsets contain only one kind of labeled data. The resulting structure is called a decision tree, where nodes stand for feature discrimination tests, while their exit branches stand for those subclasses of labeled examples satisfying the test. A tree is rewritten to a collection of rules, one for each leaf in the tree. Every path from the root of a tree to a leaf gives one initial rule. The left-hand side of the rule contains all the conditions established by the path and thus describe the cluster. In one form, the rules are extracted from a decision tree.

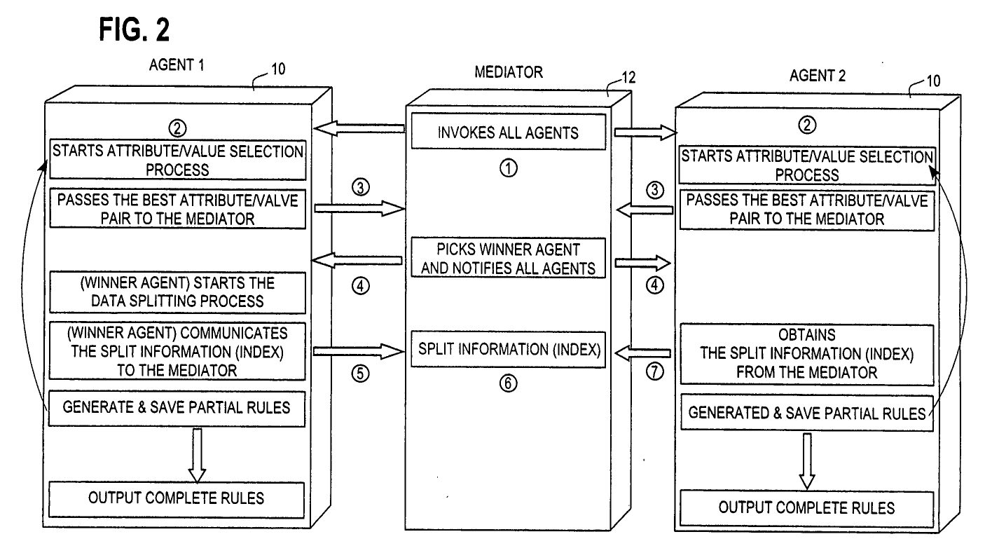

In a distributed framework, tree induction is accomplished through a partial tree generation process and an synchronized Agent-Mediator communication mechanism, such as shown in FIG. 2 that executes the following steps:

1. Clustering starts with the mediator 12 issuing a call to all the agents 10 to start the mining process.

2. Each agent 10 then starts the process of mining its own local data by finding the feature (or attribute) that can best split the data into various training classes (i.e. the attribute with the highest information gain).

3. The selected attribute is then sent as a candidate attribute to the mediator 12 for overall evaluation.

4. Once the mediator 12 has collected the candidate attributes of all the agents 10, it can then select the attribute with the highest information gain as the winner.

5. The winner agent 10 (i.e. the agent whose database includes the attribute with the highest information gain) will then continue the mining process by splitting the data using the winning attribute and its associated split value. This split results in the formation of two separate clusters of data (i.e. those satisfying the split criteria and those not satisfying it).

6. The associated indices of the data in each cluster are passed to the mediator 12 to be used by all the other agents 10.

7. The other (i.e. non-winner) agents 10 access the index information passed to the mediator 12 by the winner agent 10 and split their data accordingly. The mining process then continues by repeating the process of candidate feature selection by each of the agents 10.

8. Meanwhile, the mediator 12 is generating the classification rules by tracking the attribute/split information coming from the various mining agents 10. The generated rules can then be passed on to the various agents 10 for the purpose of presenting them to the user through advanced 3D visualization techniques.

Decision Model

In one form, the decision model used for analyzing supply chain risk is a decision tree. The decision-making analysis can be performed in a variety of manners such as synchronized (as described above) and sequential decision-making. In one form, one leaf may lead to a high risk condition warranting an alert to government personnel.

Mediation Process

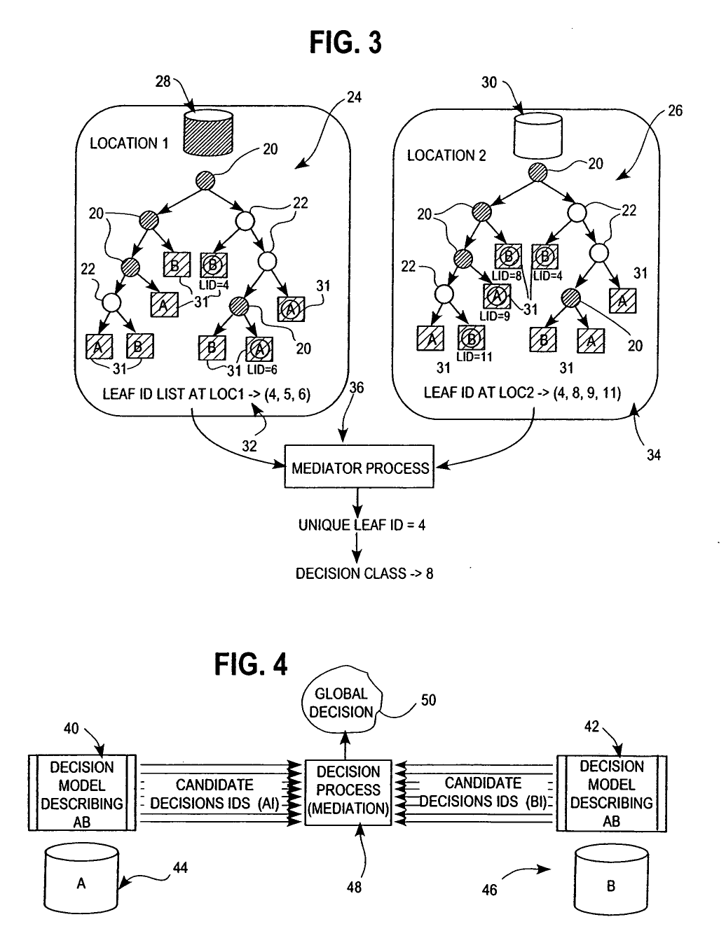

FIG. 3 depicts the mediation process that searches for a globally unique decision ID by matching local data, represented by dark circles 20 and light circles 22 to two decision trees 24,26 located at Location 1 performed by agent 28 and Location 2 performed by agent 30 respectively. Each circle 20,22 on the tree represents a decision point, while the leafs, depicted as shaded boxes 31, represent the final decision class with one of two possible values: A or B.

A prediction module is used to match the testing data with an existing model. All the existing agents 28,30 perform a prediction for each example in the following manner. All the agents 28,30 have the same decision tree, such as decision tree 24 or 26, but do not have all the attributes needed to pass through the decision tree. Hence, while passing through the tree, it goes down the appropriate branch, if it has a value for that attribute, else it goes through both the branches. Finally, each agent 28,30 creates a list 32,34 of leaf nodes it reached and sends this list to the mediator. The mediator makes a decision by finding the common leaf node among all the lists. There will always be only one common leaf node among all the lists 32,34, since there is always a unique path when all the attributes are known for the decision tree.

The decision at any given node involves the test of some attribute, the outcome of which determines how the object under consideration is sorted down the tree (i.e. which decision path is taken). However, since each agent 28,30 only has access to its own local database, it can only partially resolve the decisions to be made at decision points down a given path. Here, for example, the agent 28 at Location 1 can only test the attributes at decision nodes represented by circles 20. For example, based on the value of the attribute at the root node, the agent 28 has decided that the decision path lies on the right hand side of the node. However, at the next decision point, represented by circle 22, the agent 28 can not determine the exact decision path, as it lacks access to the attribute under consideration (i.e. the value of this attributes resides in Location 2). As such, the agent 28 should follow the decision path on both side of this particular decision node. This leads to a leaf node 31 (LID=4) with decision class B and another sub-tree to be further explored by the agent 28. A continuation of this process ultimately leads to a final list 32 of possible decision leafs, namely LID 4, 5, and 6. Similarly, the agent 30 at Location 2 is only able to resolve the decisions at the nodes represented by circles 22 and ultimately arrives at its own final list 34 of possible decision leafs, here LID 4, 8, 9, and 11. It is then the job of a mediator 36 to come up with a final decision by finding the common decision leaf ID between the lists 32,34 generated by the two agents 28,30. Here, LID 4 is determined to be the final decision leaf which in turn returns a value of B as the final decision class.

Decision-making for supply chain risk assessment can be performed in a variety of manners using decision trees. For example, this decision-making can be performed in a synchronized process or it may be performed in a sequential process. Each of these processes will be described in more detail below.

Synchronized Decision-Making

As shown in FIG. 4, a decision model 40,42 containing a set of conditional rules describing the A and B elements of distributed data record is maintained at each data locale 44,46. These data elements are matched to the predictive risk model to generate a set of candidate decisions, as shown in FIG. 3. Sets of candidate decisions are sent to the mediation process 48 that finds a globally unique decision 50 for the globally distributed data records.

Sequential Decision-Making

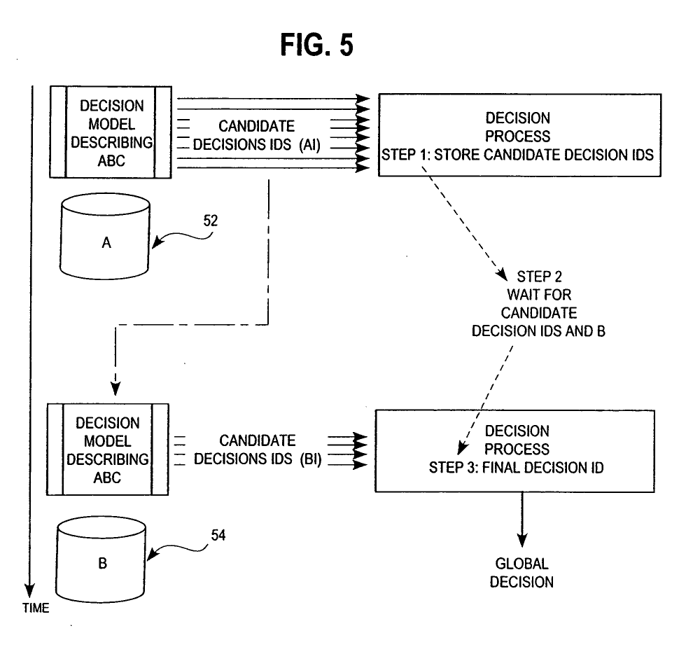

In the sequential decision-making case, as depicted in FIG. 5, the candidate decisions set is computed first at the data locale A by a software agent 52. This step is followed by the step in which the locale B agent 54 computes its set of candidate decisions, reads the candidate decisions from the agent 54 at the data locale B and starts the mediation process in a centralized coordinated server that assesses the risk patterns from database A and B.

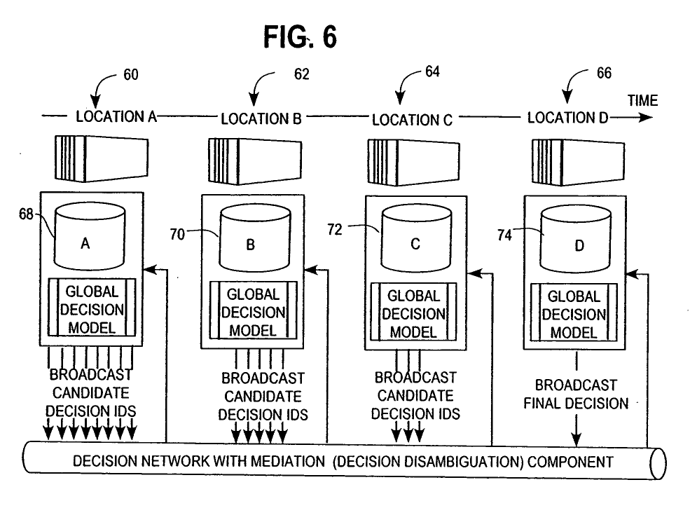

FIG. 6 depicts this sequential decision-making with more then two data locales 60,62,64,66. At each consecutive step, the mediation process finds the current set of candidate decisions based on the previously received contributions from the risk prediction software agents 68,70,72,74. This can be seen as the disambiguation process in which as more data is matched to the global model during subsequent steps, the mediation process eliminates candidate decisions from the set until it finds the globally unique one model that assembles risk scores from multiple data sources.

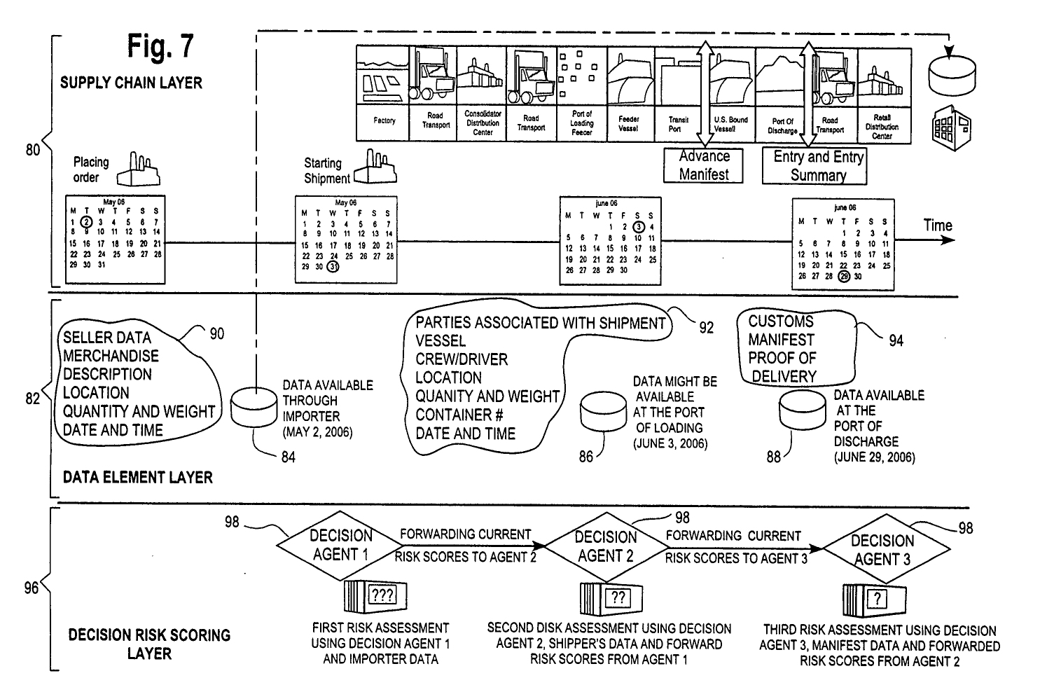

FIG. 7 depicts the application scenario of the sequential decision-making to the supply chain. The following three layers can be distinguished in this scenario:

A supply chain layer 80. This layer 80 represents actual sequence of events from placing an order to the point of container arrival at Customs. For the illustrative purpose, this process starts on May 2, 2006 and completes on Jun. 29, 2006.

A Data Element Layer 82. In one form, this layer 82 includes three data silos 84,86,88, that is, database sources which can be modeled for risk scoring. May 2, 2005 Data Silo, represented by reference number 84, may include a number of data elements 90 such as seller data, merchandise description, location, quantity and weight, date and time. Jun. 3, 2006 Data Silo, represented by reference number 86, may include a number of data elements 92 such as parties associated with shipment, vessel, crew/driver, location, quantity and weight, container ID, date and time. Jun. 29, 2006 Data Silo, represented by reference number 88, may include a number of data elements 94 such as customs manifest and proof of delivery.

A decision risk scoring layer 96. In one form, this layer 96 includes a plurality of decision agents 98 and decision risk models 100. It should be understood that some of the models 100 may be high risk detection models while others are low risk models.

It should be appreciated that the above example is an application of one form of the present method and system. It should be understood that variations of the method are also contemplated as understood by those skilled in the art. Furthermore, it should be understood that the methods described herein may be embodied in a system, such as a computer, network and the like as understood by those skilled in the art. The system may include one or more processing units, hard drives, RAM, ROM, other forms of memory and other associated structure and features as understood by those skilled in the art. It should be understood that multiple processing units may be used in the system such that one processing units performs certain functions at one data locale, a second processing unit performs certain functions at a second data locale and a third processing unit acts as a mediator.

The matter set forth in the foregoing description and accompanying drawings is offered by way of illustration only and not as a limitation. While particular embodiments have been shown and described, it will be obvious to those skilled in the art that changes and modifications may be made without departing from the broader aspects of applicants' contribution. The actual scope of the protection sought is intended to be defined in the following claims when viewed in their proper perspective based on the prior art.

1. A method for determining supply chain risks, the method comprising the steps of:
providing a plurality of data locations, each data location having an agent and data elements;
performing distributed data mining by each of the agents using the data elements at the respective data location to produce a candidate decision for the respective location;
determining a global decision from the candidate decisions, the global decision covering the data elements at all of the data locations; and
generating predictive risk scores for the data elements from the global decision.

2. The method of claim 1 wherein the step of performing distributed data mining utilizes a decision tree.

3. The method of claim 1 wherein the steps a performing distributed data mining and determining a global decision are performed by a synchronized decision-making process.

4. The method of claim 1 wherein the steps a performing distributed data mining and determining a global decision are performed by a sequential decision-making process.

5. The method of claim 1 wherein the data elements include information specific to shipping containers such that the risk scores are generate for each specific shipping container.

6. The method of claim 5 further comprising the step of reporting a high-risk score.

7. The method of claim 1 wherein the data elements include information related to at least one of: seller data, merchandise description, location, quantity, weight, date, parties associated with a shipment, vessel, crew, customs manifest and proof of delivery.

8. A method for determining supply chain risks, the method comprising the steps of:
providing a plurality of data locations, each data location having an agent and data elements;
performing distributed data mining by each of the agents using the data elements at the respective data location to produce a candidate decision for the respective location;
passing each of the candidate decisions from the respective data location to a central mediator;
determining a global decision by the mediator based on the candidate decisions; and
generating predictive risk scores for the data elements from the global decision.

9. The method of claim 8 wherein the step of performing distributed data mining utilizes a decision tree.

10. The method of claim 8 wherein the data elements include information specific to shipping containers such that the risk scores are generate for each specific shipping container.

11. The method of claim 10 further comprising the step of reporting a high-risk score.

12. The method of claim 8 wherein the data elements include information related to at least one of: seller data, merchandise description, location, quantity, weight, date, parties associated with a shipment, vessel, crew, customs manifest and proof of delivery.

13. A method for determining supply chain risks, the method comprising the steps of:
providing a plurality of data locations, each data location having an agent and data elements;
performing distributed data mining by a first agent using the data elements at a first data location to produce a first candidate decision;
passing the first candidate decision to a second data agent at a second location;
performing distributed data mining by the second agent using the data elements at the second data location to produce a second candidate decision;
determining a global decision from the candidate decisions, the global decision covering the data elements at all of the data locations; and
generating predictive risk scores for the data elements from the global decision.

14. The method of claim 13 wherein the step of performing distributed data mining utilizes a decision tree.

15. The method of claim 13 wherein the data elements include information specific to shipping containers such that the risk scores are generate for each specific shipping container.

16. The method of claim 15 further comprising the step of reporting a high-risk score.

17. The method of claim 13 wherein the data elements include information related to at least one of: seller data, merchandise description, location, quantity, weight, date, parties associated with a shipment, vessel, crew, customs manifest and proof of delivery.

18. The method of claim 13 further comprising the steps of:
determining an intermediate decision based on the first and second candidate decisions;
passing the intermediate decision to a third data agent; and
performing distributed data mining by the third agent using the data elements at a third data location to produce a third candidate decision.

19. A system for determining supply chain risks, the system comprising:
at least one memory unit at each of a plurality of locations, the at least one memory unit storing data elements;
a processing unit at each of the plurality of locations, each processing unit including an agent configured to perform distributed data mining using the data elements at the respective data location to produce a candidate decision for the respective location; and
a mediator, the mediator configured to determine a global decision from the candidate decisions, the global decision covering the data elements at all of the data locations, the mediator also being configured to generate predictive risk scores for the data elements from the global decision.

20. The system of claim 20 wherein the mediator is a central processing unit.

21. The system of claim 20 wherein the mediator is at least one of the processing units at one of the plurality of locations.
